(19) United States
(12) Patent Application Publication
(10) Pub. No.: US 2006/0181512 A1
(43) Pub. Date: Aug. 17, 2006

(54) Mouse

(75) Inventors: Ching-Cheng Wang, Dashi Township (TW); Jung-Wen Chang, Lu Chu Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/234,949

(22) Filed: Sep. 26, 2005

(30) Foreign Application Priority Data
Feb. 17, 2005 (TW) 94104602

(51) Int. Cl. G09G 5/08

(52) U.S. Cl. 345/163

(57) ABSTRACT

A mouse comprises a body and a supportive housing. The supportive housing is disposed on the body and shifted between a first position and a second position, wherein when the supportive housing is in the first position, the supportive housing contacts and supports the palm of a user.

### BACKGROUND

The invention relates to a mouse, and more particularly to an ergonomic mouse utilized in a computer system.

Some mice, such as a mini-mouse, have become gradually smaller and more easily carried and controlled. A smaller mouse, however, offers less support for the palm of a user. For example, when operating a mini-mouse, a user makes contact with a surface on a portion near their wrist joint, and moves mini mouse forward, backward, rightward, and leftward. The wrist joint may experience fatigue after long term use due to the limited support provided by the conventional mini-mouse.

### SUMMARY

An embodiment of a mouse comprises a body and a supportive housing. The supportive housing is disposed on the body and shifts between a first position and a second position, wherein when the supportive housing is in the first position, the supportive housing contacts and supports a palm of a user.

The invention increases palm support, reduces load on the wrist, and increases the efficiency and comfort.

### BRIEF DESCRIPTION OF THE DRAWINGS

The invention will be more fully understood from the following detailed description and the accompanying drawings, given by the way of illustration only and thus not intended to limit the disclosure.

FIG. 1a shows a supportive housing of a mouse of the invention in a first position;

FIG. 1b shows the supportive housing in a second position;

FIG. 2 shows the supportive housing supporting a palm of a user;

FIG. 3a is a front exploded view of an elastic structure of the invention;

FIG. 3b is a side exploded view of the elastic structure of the invention;

FIG. 3c is a perspective exploded view of the elastic structure of the invention;

FIG. 3d is a side view of the elastic structure of the invention;

FIGS. 4a-4e show the operation of the elastic structure;

FIG. 5a shows a first force applied on the mouse;

FIG. 5b shows a second force applied on the mouse.

### DETAILED DESCRIPTION

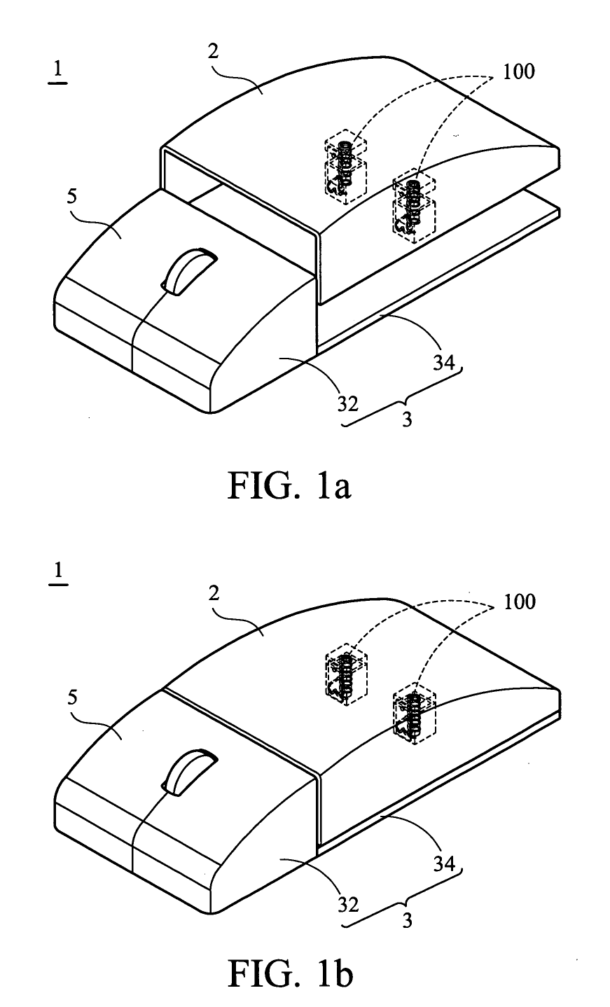

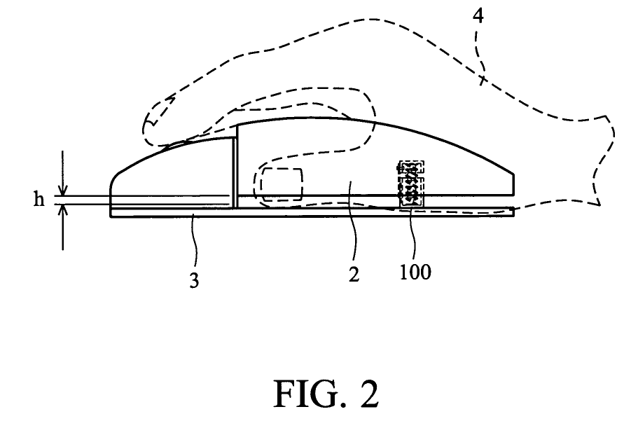

FIGS. 1a and 1b show a mouse 1 of the invention, which comprises a supportive housing 2, a body 3, a control interface 5 and an elastic structure 100. The control interface 5 is disposed on a front portion 32 (first portion) of the body 3. The supportive housing 2 is disposed on a rear portion 34 (second portion) of the body 3 next to the control interface 5. In the invention, a cross-section of the supportive housing 2 is a substantially inverted U-shaped, extending along a curve from the control interface 5 to a rear end of the body 3. The elastic structure 100 is disposed between the rear portion 34 and the supportive housing 2. The elastic structure 100 allows a user to shift the supportive housing 2 between a first position (the position as shown in FIG. 1a) and a second position (the position as shown in FIG. 1b). The first position and the second position are at different height level. When the user operates the mouse 1, the supportive housing 2 is in the first position and supports a palm of the user. When the user carries the mouse 1, the user shifts the supportive housing 2 up to the second position for easy transport.

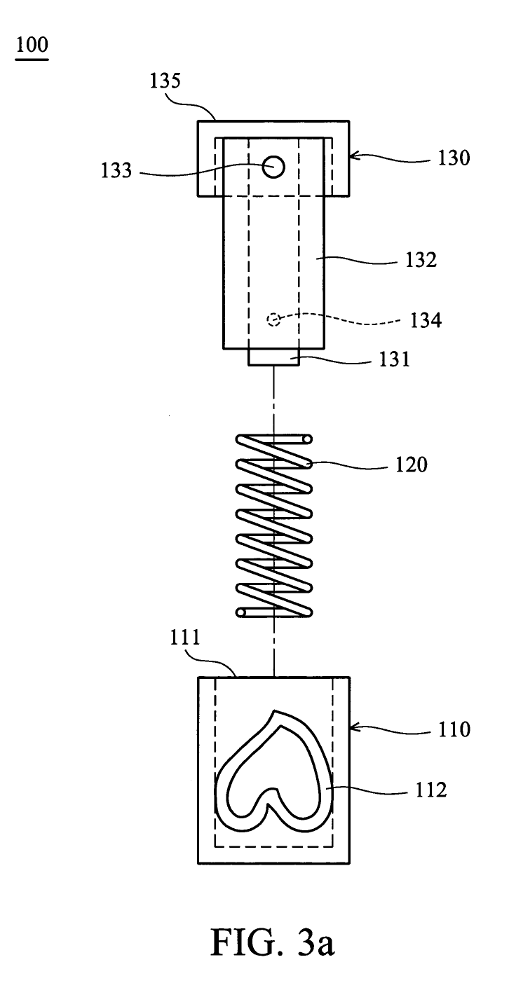

As shown in FIG. 2, a distance h is formed between the first position and the second position. When the supportive housing 2 is in the first position, the supportive housing 2 contacts and supports the palm of the user. Thus, the user feels more comfortable when operating the mouse.

The elastic structure 100 is described in detail in the following.

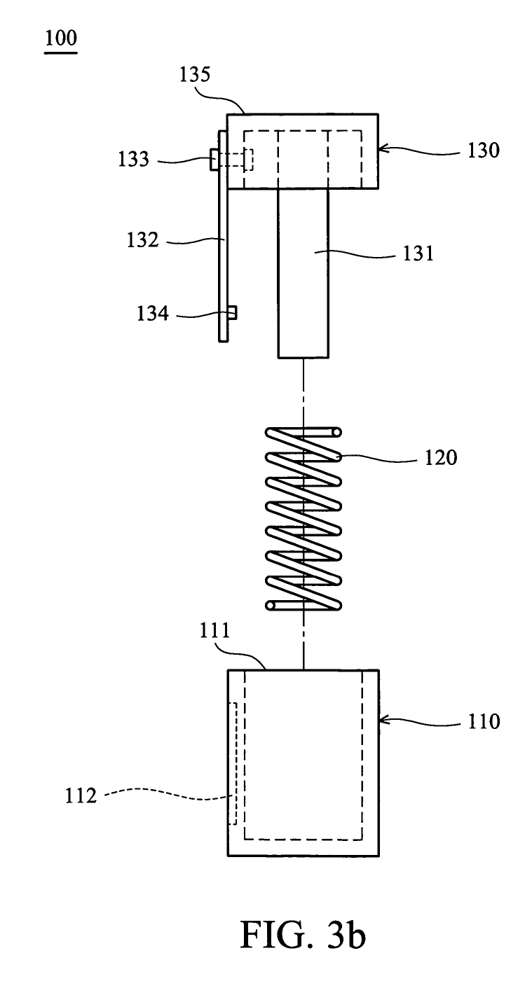

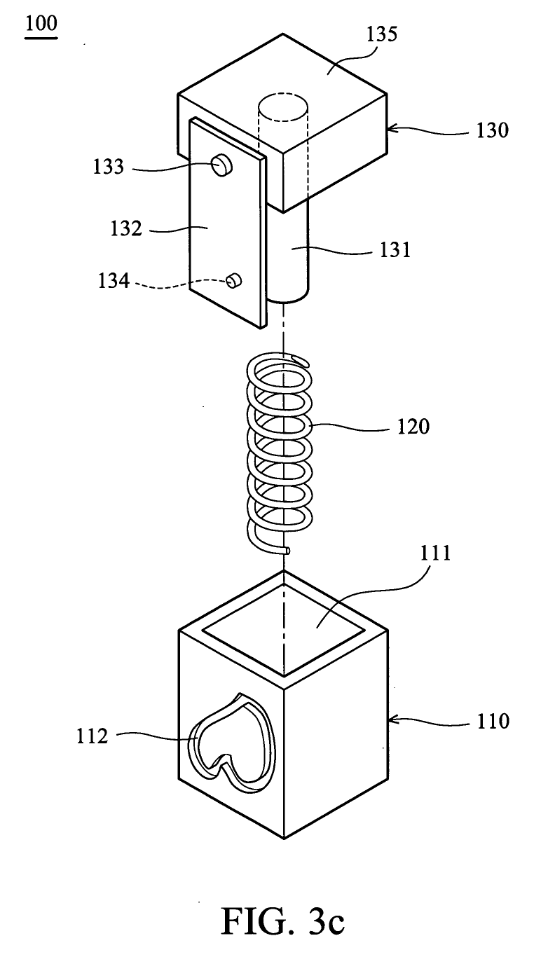

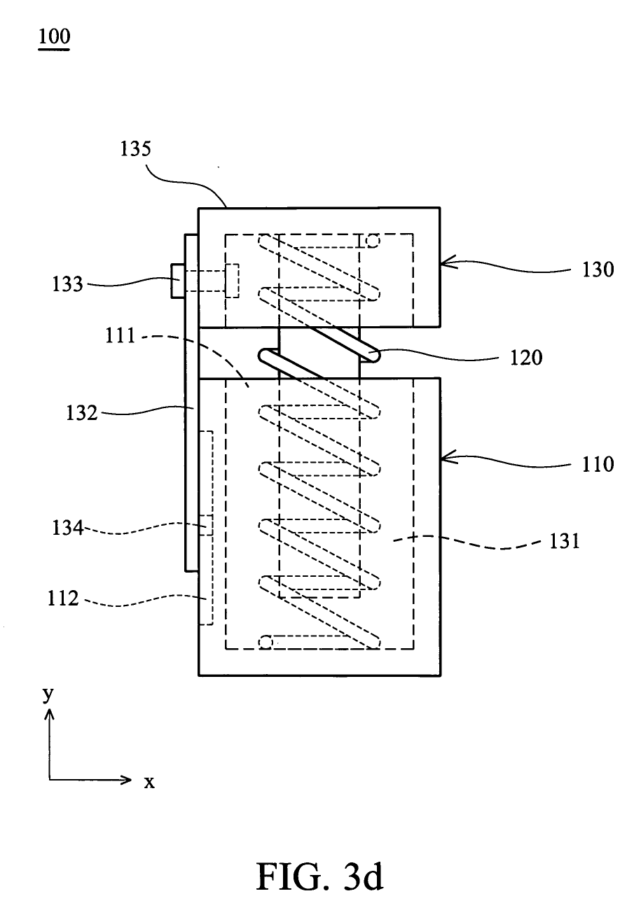

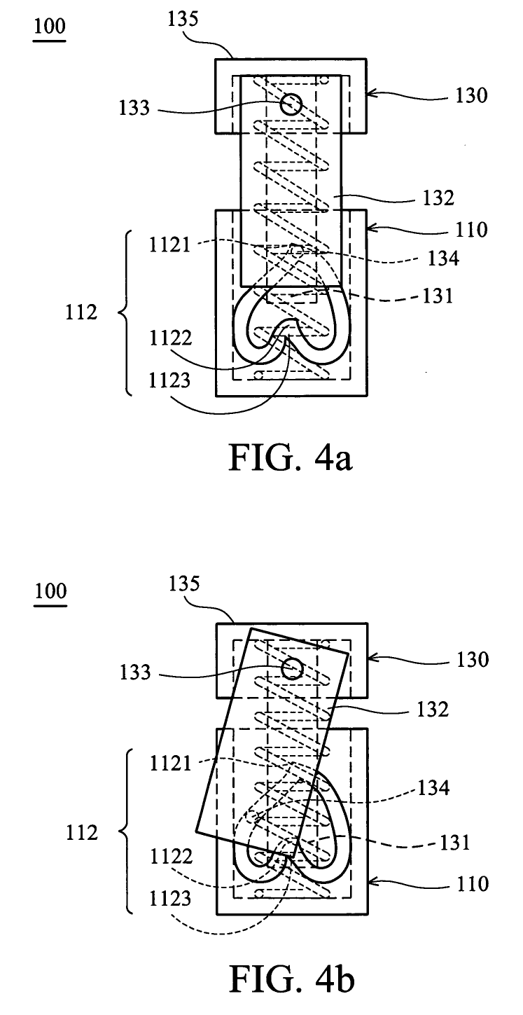

FIG. 3a is a front exploded view of the elastic structure 100, which comprises a fixing element 110, a spring (elastic element) 120 and a moveable element 130. The fixing element 110 is a cuboid chamber disposed on the rear portion 34 of the body 3, and comprises an opening 111 and a guide groove 112. The guide groove 112 is an enclosed inverted heart-shape structure disposed on an outer surface of the fixing element 110. The moveable element 130 comprises a cylinder 131, a flat piece 132 and a connecting portion 135. The connecting portion 135 is fixed to the supportive housing 2. The cylinder 131 is fixed on the connecting portion 135. The flat piece 132 comprises a protrusion 134 (guiding element) and pivots on the connecting portion 135 by a rivet 133. A surface of the flat piece 132 is parallel to a major axis of the cylinder 131. FIG. 3b is a side exploded view of the elastic structure 100, wherein the protrusion 134 is disposed on the flat piece 132 and extends into the guide groove 112. FIG. 3c is a perspective exploded view of the elastic structure, wherein the guide groove 112 is formed on the outer surface of the fixing element 110.

FIG. 3d shows an assembled elastic structure 100. The cylinder 131 is inserted into the fixing element 110 through the opening 111. The spring 120 surrounds the cylinder 131, and contacts the fixing element 110 and the connecting portion 135. The cylinder 131 prevents the connecting portion 135 from moving in a horizontal direction x corresponding to the fixing element 110. The spring 120 provides an elastic force in a vertical direction y between the fixing element 110 and the connecting portion 135. The protrusion 134 slides in the guide groove 112.

The operation of the elastic structure 100 is described in the following description.

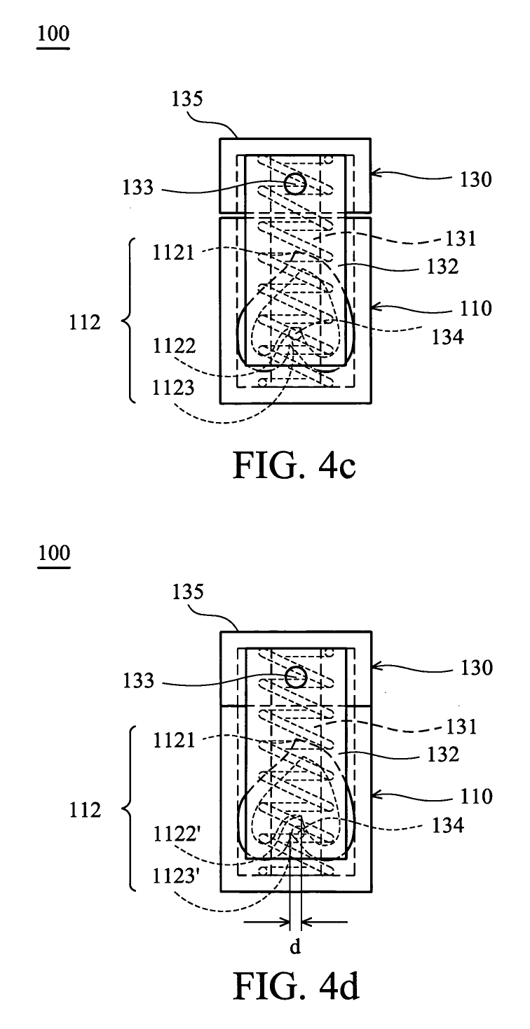

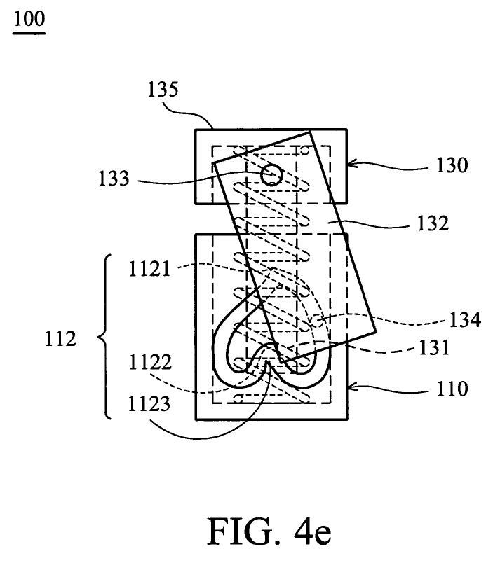

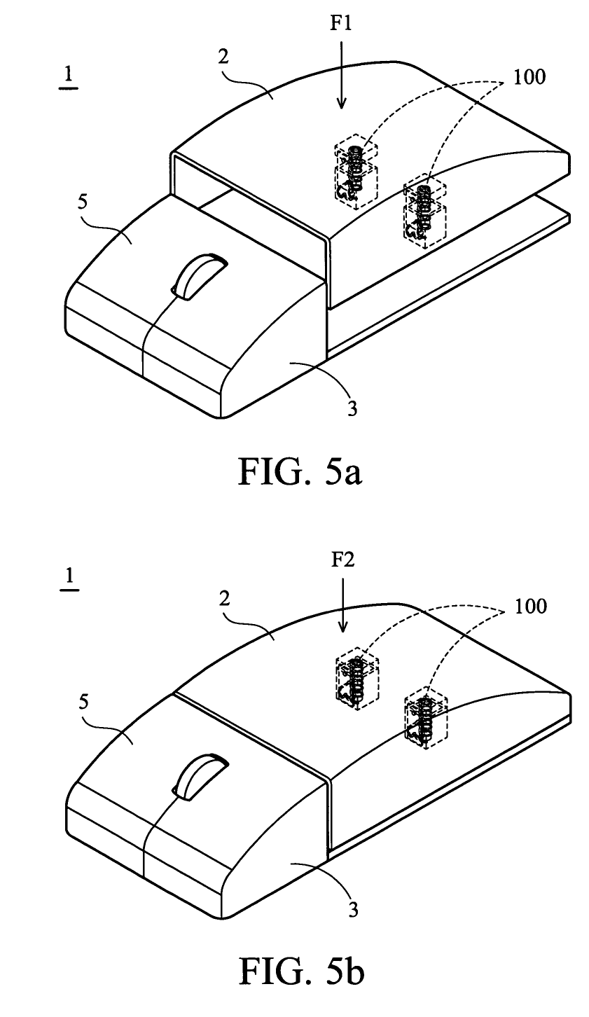

With reference to FIGS. 4a and 5a, when the supportive housing 2 is in the first position, the protrusion 134 is in a first groove position 1121 in the guide groove 112 (at the top of the inverted heart), abutting an inner wall of the guide groove 112 near the first groove position 1121, and sustains the supportive housing 2 in the first position. To change the position of the supportive housing 2 from the first position, a first force F1 is exerted on the supportive housing 2 (as shown in FIG. 5a), shifting the supportive housing 2 from the first position to the second position, and shifts the protrusion 134 toward a second groove position 1122 along a first side part of the guide groove 112, as shown in FIG. 4b. When the first force F1 is removed, as shown in FIG. 4c, the protrusion 134 is shifted to the second groove position 1122 (the notch of the inverted heart) by the spring, the protrusion 134 abuts the inner wall of the guide groove 112 near the second groove position 1122, the spring is compressed, and the supportive housing 2 is in the second position (as shown in FIG. 1b).

As shown in FIG. 4d and 5b, when the user wants to change the position of the supportive housing 2 from the second position, the user applies a second force F2 on the supportive housing 2, and shifts the protrusion 134 to a third groove position 1123 below the second groove position 1122. With reference to FIG. 4e, when the protrusion 134 is shifted to the third groove position 1123, the second force F2 is removed, and the spring 120 pushes the protrusion 134 toward the first groove position 1121 along a second side part of the guide groove 112. Then, the supportive housing 2 returns to the first position from the second position. A vertex 1123′ of the inner wall near the third groove position 1123 comprises a horizontal distance d from a vertex 1122′ of the inner wall near the second groove position 1122. By this arrangement, the protrusion 134 in the third groove position 1123 cannot travel over the vertex 1123′ back to the first side part of the guide groove 112.

The protrusion 134 thus reciprocates between the first groove position 1121 and the second groove position 1122 in a guided direction (counter-clockwise direction) in the guide groove 112. When the protrusion 134 stays in the first groove position 1121, the supportive housing 2 is in the first position supporting the palm of the user. When the protrusion 134 stays in the second groove position 1122, the supportive housing 2 is in the second position reducing the size of the mouse.

The invention increases the support of the palm, decreasing a load upon the wrist, and increases efficiency and comfort of the user.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A mouse, comprising:
a body; and
a supportive housing, disposed on the body and shifted between a first position and a second position, wherein when the supportive housing is in the first position, the supportive housing contacts and supports a palm of a user.

2. The mouse as claimed in claim 1, wherein the body comprises a front portion and a rear portion, and the supportive housing is disposed on the rear portion.

3. The mouse as claimed in claim 2, wherein a distance between the first position and the rear portion is greater than a distance between the second position and the rear portion.

4. The mouse as claimed in claim 1, wherein the first position is higher than the second position.

5. The mouse as claimed in claim 1, wherein the supportive housing is shifted between the first position and the second position by elastic force.

6. The mouse as claimed in claim 5, further comprising an elastic structure disposed between the supportive housing and the body, the elastic structure comprising:
a fixing element, disposed on the body;
a moveable element, disposed on the supportive housing;
an elastic element, disposed between the fixing element and the moveable element, contacting the fixing element and the moveable element,
wherein the elastic element pushes the supportive housing from the second position to the first position.

7. The mouse as claimed in claim 6, wherein the fixing element comprises a guide groove which is an enclosed inverted heart-shape, the guide groove is formed on a surface of the fixing element, and comprises a first groove position and a second groove position.

8. The mouse as claimed in claim 7, wherein the moveable element comprises a guide portion, extending into the guide groove, and reciprocates between the first groove position and the second groove position in a guide direction, wherein when the guide portion abuts against an inner wall of the guide groove and stays in the first groove position, the supportive housing is in the first position, and when the guide portion abuts against the inner wall of the guide groove and stays in the second groove position, the supportive housing is in the second position.

9. The mouse as claimed in claim 1, further comprising a control interface disposed on the body.

10. The mouse as claimed in claim 7, wherein the body comprises a first portion and a second portion, the first portion connecting the second portion, the control interface disposed on the first portion, and the supportive housing is disposed on the second portion.
